(19) United States
(12) Patent Application Publication
(10) Pub. No.: US 2011/0023364 A1
(43) Pub. Date: Feb. 3, 2011

(54) MOUNTING FIXTURE FOR A LIGHT BARRIER AND USE OF SAME

(75) Inventors: Patrick Euteneuer, Melle (DE); Michael Sanke, Rheda-Wiedenbruck (DE)

Correspondence Address: GLOBAL IP COUNSELORS, LLP, 1233 20TH STREET, NW, SUITE 700, WASHINGTON, DC, 20036-2680, US

(73) Assignee: HORMANN KG ANTRIEBSTECHNIK

(21) Appl. No.: 12/095,690

(22) PCT Filed: Nov. 22, 2006
(86) PCT No.: PCT/DE06/02060

§ 371 Date: Oct. 19, 2010

(30) Foreign Application Priority Data
Nov. 30, 2005 (DE) 10 2005 057 797.0
Mar. 2, 2006 (DE) 10 2006 009 713.0

(51) Int. Cl. E05F 15/20; F16M 13/02; F16B 2/02; F16B 2/20; H01J 5/02

(52) U.S. Cl. 49/25; 248/205.1; 248/226.11; 248/224.8; 248/231.81; 250/239

(57) ABSTRACT

A retaining arrangement is provided with at least one light-barrier fastening device for fastening the light-barrier element on the retaining arrangement, and with at least one first door-fastening device, for fastening the retaining arrangement on an element of a first type of door, and also with at least one second door-fastening device for fastening the retaining arrangement on an element of a second type of door, and/or with a floor-fastening/ground-fastening or wall-fastening device, for fastening the retaining arrangement on the floor/ground or a surrounding wall and/or on an element of an undetermined type of door.

The invention relates to a mounting fixture for securing a light barrier element of a light barrier device in the region of a doorway to be closed off by a door. In addition, the invention relates to a light barrier device provided with one such mounting fixture as well as to a door provided with such devices and a door operator system. The invention is pertinent particularly to the field of automated doors and to the field of door operators.

It has been known for a long time to provide automated doors with a protective device to prevent a motorized door leaf from coming up against an obstacle in the doorway.

So-called edge sensors are widely popular, there being one embodiment thereof on the market in which the edge sensor is provided with flexible tubing within which a light barrier link is routed. When the door comes up against an obstacle the tubing is pinched, disrupting the light barrier link. This disruption of the light barrier link results in the door operator powering the door leaf being halted and/or reversed. In such a light barrier link the elements of the light barrier device are secured to the ends of the tubing.

The elements of a light barrier device or light barrier elements as referred to in the following are particularly the components of a light barrier device serving to make a light barrier link, in other words, particularly a light barrier transmitter, a light barrier receiver or a transceiver or a reflector suitable for light barriers. These elements can be devised for transmitting, receiving and reflecting respectively any kind of light beams or other directed electromagnetic radiation for detecting objects, be it in the visible or invisible range, but particularly in the infrared range

Known from WITHOUT 88/02 804 is a light barrier device mounted on a door by a mounting fixture for a light barrier element permitting the light barrier element to be inserted in a bottom closure element of the door leaf.

Apart from such light barrier systems moving with the door it is also known to monitor door actioning by light barriers whose light barrier elements are secured stationary in the region of the doorway, as a rule in a lower portion of the doorway so as to cover the full width of the doorway and also arranged as near as possible thereto so that any obstacle standing in the way is reliably detected. It is mostly the case that doors have a fixed door frame and a door leaf guided thereon or therein, often in the form of a door panel. The nature and design of the fixed door element, especially the door frame, as well as of the door leaf or door panel differ depending on the design and type of door involved. There is a wealth of different types of doors such as lift doors, pivot doors, swing doors, canopy doors, single-lead overhead doors, sectional doors, rollup doors, revolving doors, revolving panel doors, side sectional doors, folding doors and sliding doors; and among these different types of door there are differing aspects thereof. To achieve the cited arrangement of the light barrier elements a mounting fixture adapted to the situation involved is needed. A broad acceptance of the light barrier systems known hitherto is hampered by the high price of having to adapt them to each particular situation.

One factor hiking the price of a door operator system is also the time to install the system. Because a light barrier meant hitherto a serious addition to the work involved, most door operator systems hitherto lack a light barrier or can only be fitted out with a light barrier on special request at corresponding extra cost.

The basic object of the invention is thus to sophisticate a light barrier system for monitoring a door operator or a door powered thereby so that it can now be simply fitted to the various types and/or designs of door involved.

This object is achieved by a mounting fixture for one such light barrier system having the features as set forth in claim 1 and/or claim 2 as well as by a light barrier device provided therewith as it reads from claim 28.

A door operator provided therewith as well as a door provided therewith, particularly in the form of a sectional door or a single leaf overhead door as well as a door system comprising diverse types and aspects of the door read from the subject matter of the further independent claims.

Advantageous aspects of the invention read from the sub-claims.

The mounting fixture in accordance with the invention thus features a light barrier fastening means by which a light barrier element—for instance the transmitter or receiver or a transceiver or a reflector—can be secured to the mounting fixture. The mounting fixture comprises furthermore at least one door fastening means for securing the mounting fixture to an element of a door. In accordance with one aspect of the invention at least two such door fastening means are provided adapted for securing to diverse elements of diverse types and designs of door or it is provided for in accordance with another aspect of the invention that in addition to a door fastening means, adapted for securing the mounting fixture to the element of a door, a floor or wall fastening means are provided by means of which the mounting fixture can be secured to the floor or a wall in the region of the doorway (which may also be a door post). In a particularly preferred aspect of the invention both at least two diverse door fastening means for securing to two differing types of door and a floor or wall fastening means for securing to floor or a wall are provided.

This now allows the site fitter, depending on the situation involved, to chose between at least two options for making the fastening. For example, a first door fastening means can be provided designed for securing to the frame of a sectional door, for instance, and a second door fastening means designed for securing to the frame of a single leaf overhead door, such as particularly a overhead door.

This simplifies fitting since special adaptations to mounting and/or positioning aids can now be provided at the door, resulting in even a non-professional fitter to do the job correctly. In addition to this, the complications in adapting to local circumstances are reduced since a mounting fixture is now compatible with several types of door or several different door elements of various door designs. This saves on the number of parts needing to be fitted and the necessity of having to select the suitable parts from a multitude of parts as included in delivery or available for ordering.

Many door operators on the market are already devised for optional operation of diverse types of doors, such as optional operation of sectional doors or up and over doors. With a corresponding mounting fixture a light barrier can now be simply assigned to the door operator for use just as universally as the door operator.

In addition, or as an alternative, to the second door fastening means the floor and/or wall fastening means can be provided which finds particular application when no door element is available compatible with one of the door fastening means. For example, instead of the arrangement on a door frame, securing it to the floor or wall in the direct vicinity of the door frame is an option. The mounting fixture can then be assigned revolving door operators for instance, where siting a light barrier monitor ahead of or behind the actual doorway is of advantage where no door frame or the like is available for fitting.

The diverse options of securing the mounting fixture are particularly simple to achieve when the mounting fixture is configured as a mounting bracket having a first leg and a second leg. The two legs in this arrangement are preferably oriented at right angles to each other in thus enabling the mounting fixture to be used as a mounting bracket for securing to the floor or for securing to the front or rear side of a door frame. When the first leg is devised longer than the second leg, this first leg can be used to secure the light barrier element more or less spaced away from the second leg. For another thing, this first leg can also be used as a mounting plate so that both door mounting and mounting the light barrier element on this first mounting bracket is permitted.

The first leg is configured preferably offset. The offset is particularly suitable to serve as a stopper means for defining the mounting fixture at a corresponding shaped wall portion of a door frame in thus finalizing the orientation of the mounting fixture.

For another thing, the offset can be put to use to advantage in positioning the light barrier element as a function of the door or floor fastening means to be employed. When orienting the offset so that the mounting bracket in the side view has roughly the shape of question mark, the second leg despite being sized, can be dimensioned to advantage for floor mounting such that it does not protrude beyond the light barrier housing when the latter is secured to a leading second free end portion of the first leg.

To render the mounting fixture even more universal in application, several light barrier fastening means are provided for optional use depending on the particular fitting situation. Thus a light barrier element can be secured differingly spaced away from door elements and/or from the floor. Or, it is just as possible, to secure the light barrier element differingly oriented relative to the door element and/or to the floor.

Preferably the longer first leg features at least two light barrier fastening means in thus enabling with the same mounting bracket two differing levels of the light beam above the floor when floor mounting or two differing spacings of the light beam from the door element to be selected as wanted when secured to the door element.

To make such a selection preferably two light barrier fastening means are arranged on the foreswept second portion, the free end portion of the second leg. In addition, or alternatively, a further light barrier fastening means can be arranged on the backswept first portion. This third light barrier fastening means can be employed for securing the light barrier when the first leg is used as a simple mounting plate (making no use of the second leg for mounting).

Preferably, however, a further light barrier fastening means is provided in addition or alternatively on the second leg to add to the possible applications of the mounting bracket in making available further possible orientations of the mounted light barrier element.

The at least one light barrier fastening means, preferably all of a plurality of light barrier fastening means is/are preferably configured such that the light barrier housing can be secured only in predefined orientations to directly provide the fitter the wanted mounting position. This can be achieved particularly simply by means of an out of round notch for engaging by a corresponding protuberance on the light barrier element so that depending on the symmetry of the notch only one, two or more orientations are possible. Particularly preferred is a square notch offering a total of four orientations of a corresponding square protuberance. Preferably furthermore each notch of the light barrier fastening means is arranged on a longitudinal centerline of the mounting fixture and thus symmetrical to thus make it easy to use this notch in a plurality of orientations of the mounting fixture. It is obviously just as possible, of course, to consider the kinematic reversal: recess or backsweep at the light barrier housing and protuberance at the mounting fixture.

To permit making use of the mounting fixture both left and right of the door for securing the one or other light barrier elements needed for the light barrier link, the mounting fixture is configured substantially mirror symmetrical in all. This may exclude a floor fastening means provided at the second leg since in corresponding upright fitting of the mounting bracket a symmetrical relative to the longitudinal centerplane is less important.

The light barrier fastening means may comprise either the corresponding polygonal rimmed notch and/or it may also feature a notch differingly shaped for door fastening, for example a right-circular shaped notch, and a positioning means for locating the light barrier element when properly oriented.

Door fastening too, becomes particularly simple when just one straightforward connection such as a detent means or bolt fastener is provided for securing to a door element, particularly the door frame. Accordingly, the at least one door fastening means features preferably a bolting hole by means of which the mounting fixture can be bolted to the door frame. This hole may also be used furthermore preferably also for other purposes, for example, for engaging a protuberance of clip of detent means fastener. To assure correct orientation of the light barrier during fitting a positioning aid is furthermore provided preferably for door fastening, preferably defined by positive connection of adapting elements on the door frame and mounting fixture. For this purpose, each of the door fastening means of the mounting fixture includes a suitable stopper means for stopping an edging of the door frame positively connected and/or non-rotatably. This stopper means may be configured particularly simply by a tab bent out from the mounting fixture preferably made of sheet metal and/or by an offset, for example, that of the first leg as already mentioned above.

In particularly preferred aspects of sectional doors an inclined projecting edging may be provided on the door frame at an edge facing away from the doorway inwardly to the bay to be closed off. Preferably the mounting fixture is configured such that a corresponding offset exactly locates this inclined edging when bolting the mounting fixture to a corresponding bolting hole of the door frame. For further exact positioning an additional clasping means may be provided, particularly in the form of a tab bent out parallel to the offset or shaped otherwise, which clasps the edging from the other side. This enables the mounting fixture to be simply mounted on this projecting edging and then bolted in place. This results in the location of the mounting fixture and thus the location of the light barrier element being precisely defined by the door frame, making for extremely simplified fitting.

For a secure adapting location and facilitated fitting the clasping means forms with the offset a hole approximately three to four mm, particularly approximately 3.5 mm wide for receiving the edging. Furthermore preferred the offset extends at an angle of approximately 44° to 48°, particularly approximately 46° to the two portions to thus achieve precise location of this inclined portion on correspondingly configured door frames of sectional doors. Furthermore, preferably both the bolting hole in the mounting fixture and a bolting hole provided in the door frame for securing the light barrier which may be a tapped bolting hole have a spacing of approximately 44 to 48 mm, preferably approximately 46 mm, each bolting hole adapted to the other.

For securing the mounting fixture to frame of a single leaf overhead door (e.g. pivot door, up and over door, canopy door) it is furthermore provided for preferably a door fastening means configured adapted to the frame at the second leg. For this purpose there is furthermore preferably provided a stopper means of the door frame configured for being secured to the frame of the single leaf overhead door on the side of the second leg opposite the first leg jutting away from the second leg.

Provided at the door frame of the single leaf overhead door is preferably a bolting hole for a light barrier fastening means, where necessary also as a tapped bolting hole, at the required level spaced approximately 14 to 16 mm, particularly 15 mm away from a vertical edge. Correspondingly the stopper means of the mounting fixture is spaced away from the center of the assigned fastener notch of the corresponding door fastening means approximately 14 to 16 mm, particularly approximately 15 mm.

Instead of a bolt fastener a clip adapter may be provided configured with two detent means protuberances facing each other, for example, on the one hand, for a securing and arresting detent means in the bolting hole each preferably configured the same in the diverse doors and, on the other, for a securing and arresting detent means in each bolting hole of a door fastening means in thus simplifying fitting without the need of a tool.

Since no such corresponding positioning or fitting aids can be provided on the floor or wall of the bay to be closed off by the door, the floor or wall fastening means is preferably configured such that the light barrier can be mounted both secure and facilitatedly oriented. For this purpose preferably the floor or wall fastening means features a first bolting hole for a first bolt/dowel combination and spaced away therefrom a second bolting hole for a second bolt/dowel combination. Whilst the first bolting hole is circular for precisely positioning, the second bolting hole is provided as a curved slot circumscribing a circular line with the first bolting hole as the centerpoint. Thus even when the angle of the four bolting holes to be provided on the left and right of the doorway for the four holes deviates, the two light barrier elements each to be mounted by one of the mounting fixtures as described can be easily oriented to face each other simply by turning them about each first bolt/dowel combination.

It is also possible to provide separate fastening means for floor and wall mounting, whereby in addition to the floor fastening means as described above a wall fastening means specially configured for wall mounting can be provided, for example, at another location of the mounting fixture, for instance at another leg of the mounting bracket. For this purpose the mounting fixture may be configured substantially U-shaped with a web and two U-shaped legs to make available even more degrees of freedom, also for mounting on a vertical wall.

A light barrier device in accordance with the invention assigned to a door operator is characterized by at least one light barrier element featuring a light barrier housing configured adapted for securing to the mounting fixture and at least one mounting fixture of the aforementioned kind for mounting this light barrier housing.

Fitting is further simplified by the light barrier housing comprising a through-hole for a bolt fastener.

The light barrier housing and the corresponding light barrier fastening means are configured preferably adapted to each other such that the light barrier housing can be secured in just a few selectable orientations to the mounting fixture in thus making it easy for the fitter to find the adapted position in each case, he having a choice, for example, of just on, two, three etc up to a maximum of eight selectable orientations.

In a particularly preferred aspect securing the light barrier housing to the mounting fixture and/or securing the mounting fixture to the door is done by a clip or detent means, thus doing away with the need for bolts and tools needed for fitting. Here too, preference is given to certain arrangements, levels and/or orientations by corresponding fastening elements and/or positioning aids on the door, mounting fixture and/or light barrier housing. For example, a detent tongue with a detent nose can be configured at the light barrier housing and a corresponding edging —be it in the region of a recess or notch or a projection or some other protruding element—adapted for being clasped by the detent tongue may be configured at the mounting fixture. A corresponding edging may also be configured at a fixed door element; i.e. particularly at a frame of the door, so that the light barrier housing can be secured optionally directly to the fixed door element or indirectly by means of the mounting fixture, the latter too featuring corresponding detents, where possible.

For detenting it is, of course, irrelevant at which of the elements to be connected a detent tongue or like detent means and at which a claspable edging is provided.

It is also possible that the detent means serves exclusively to secure the mounting fixture to the door whilst the light barrier continues to be bolted or otherwise secured, or exclusively serves to secure the light barrier device to the mounting fixture whilst the mounting fixture continues to be bolted or otherwise secured to the door. Preferably detent means or click fasteners are employed for connecting both light barrier device/mounting fixture and mounting fixture/door.

The mounting fixture is made to advantageous from sheet metal or a plastics material, both of which are affordable and well suited for mass production. Where made in sheet metal the diverse notches or recesses are easily achieved by punching; and an offset is simple to achieve by bending. Straps and tongues can be made by punching. When made in plastics even complicated shapes can be mass produced cost-effectively by injection molding, it being particularly the integrated detents that are simple to achieve thereby. The equivalent to this when made of metal would be die-casting.

The light barrier device or the mounting fixture is particularly suitable as an accessory package to a door operator. By the configuration in accordance with the invention such light barrier devices can be furnished with two light barrier elements (e.g. transmitter and receiver) and two mounting fixtures as described presently as an accessory package to each door operator suitable for a variety of door types or also just to a specific type of door. Because of the mounting fixture being universal in its application it can be secured to the diverse types of door to which the door operator is adapted. The strategy of like parts achievable by this concept makes for substantially savings in the costs of production and handling in commissioning door operators, each of which is simply furnished with the light barrier device, each engineered the same, and two of the mounting fixtures in accordance with the invention no matter for what type of door involved. Accordingly, the mounting fixtures with the light barrier elements are furnished as an accessory package just the same for reversible door operators as for shafted door operators, revolving door operators or push door operators.

The invention also relates to a combination of the corresponding door—be it a sectional door or roll door, be it a single-leaf overhead door, side hung door (involving a door wing hinged to a door post or a wall to rotate about a vertical axis) or a push door—with the light barrier device as described presently. In this arrangement the door element to be fixedly secured in each case, for instance the door frame involved, is prepared adapted to mount the mounting fixture by it preferably featuring a corresponding tapped hole for the bolt fastener to be employed with the corresponding door fastening means of the mounting fixture.

The invention also relates to a door system comprising
differing types of doors, such as particularly sectional doors and up and over doors or diverse modifications thereof, each featuring a door element, particularly a frame, adapted for fitting a light barrier by means of a mounting fixture,
the mounting fixture,
a light barrier device mountable with the mounting fixture and
one or more diverse types of door operator, suitable for operating at least one of the door types and activatable by means of the light barrier device.

The invention covers in addition each of the individual system components for such a system.

Example aspects of the invention will now be detailed with reference to the attached drawings in which:

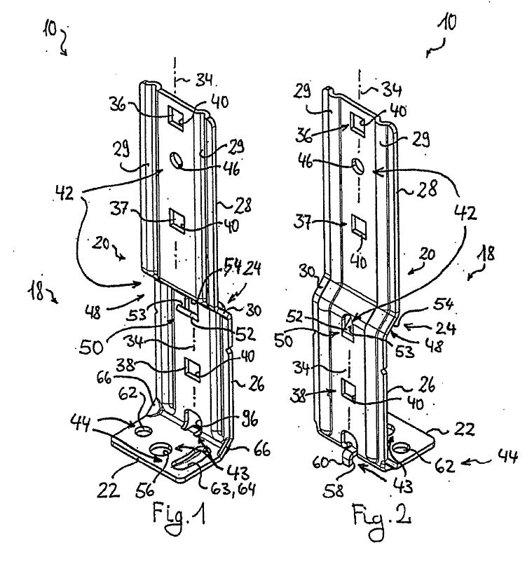

FIG. 1 is a front view in perspective of a mounting fixture for a light barrier element in the form of a mounting bracket;

FIG. 2 is rear view in perspective of the mounting bracket;

FIG. 3 is a view from underneath of the mounting bracket;

FIG. 4 is a right-hand side view of the mounting bracket;

FIG. 5 is a front view of the mounting bracket;

FIG. 6 is a left-hand side view of the mounting bracket;

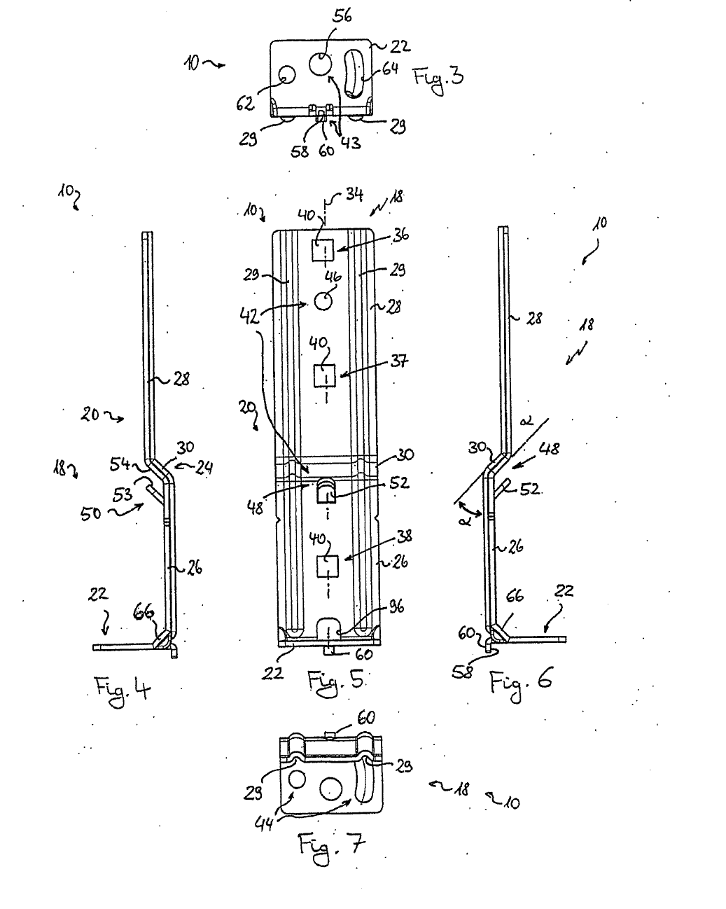

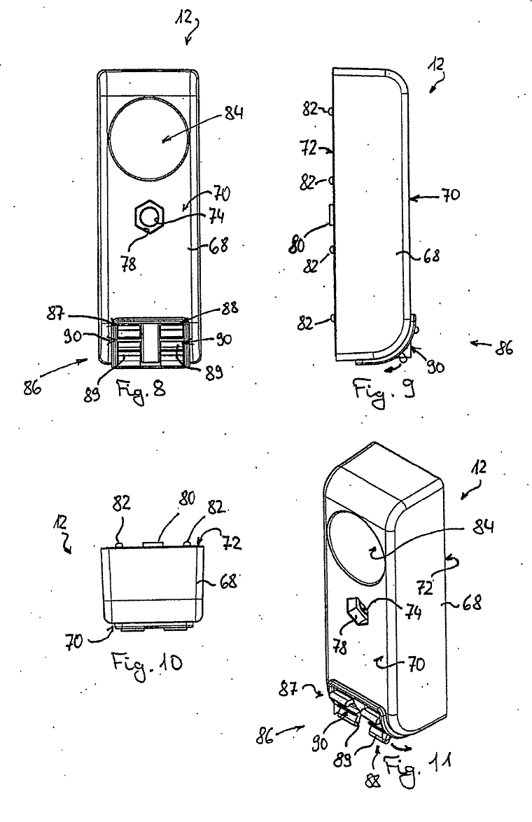

FIG. 7 is a top-down view of the mounting bracket;

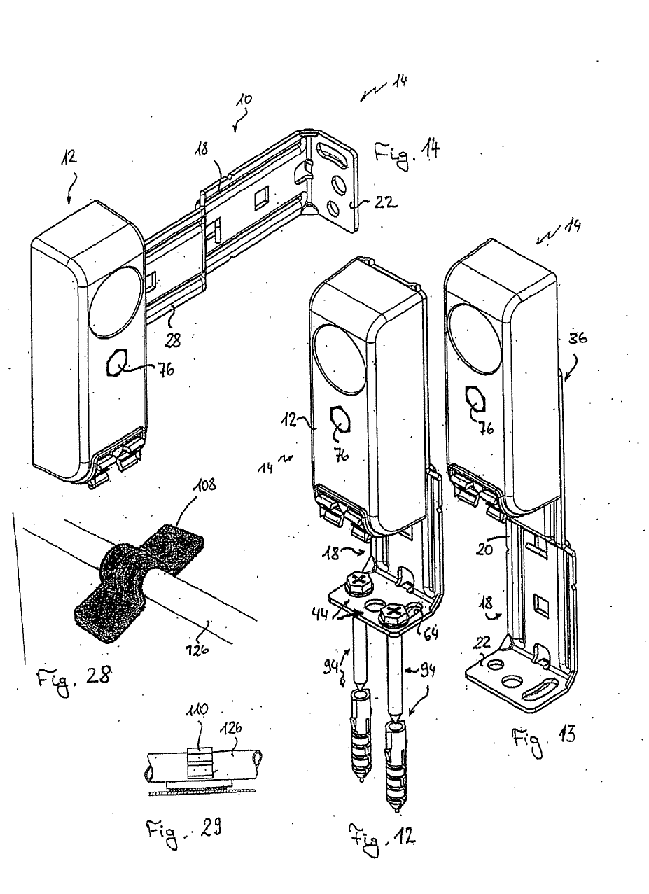

FIG. 8 is front view of a light barrier housing of a light barrier element;

FIG. 9 is a side view of the light barrier housing;

FIG. 10 is a top-down view of the light barrier housing;

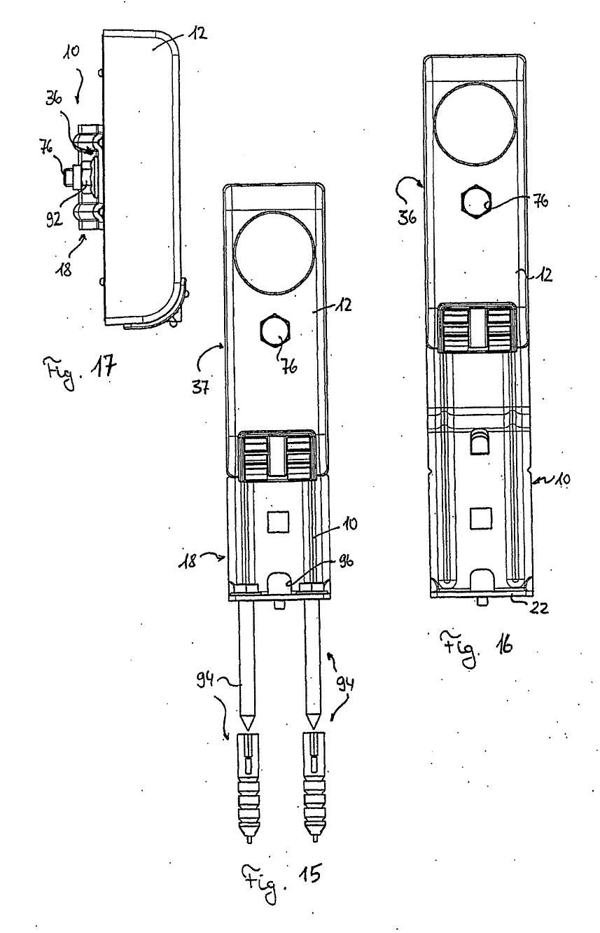

FIG. 11 is a view in perspective of the light barrier housing in a front, top-down and side view;

FIG. 12 is a view in perspective of the light barrier housing secured to the mounting bracket in a first position, this first position being suitable for floor mounting;

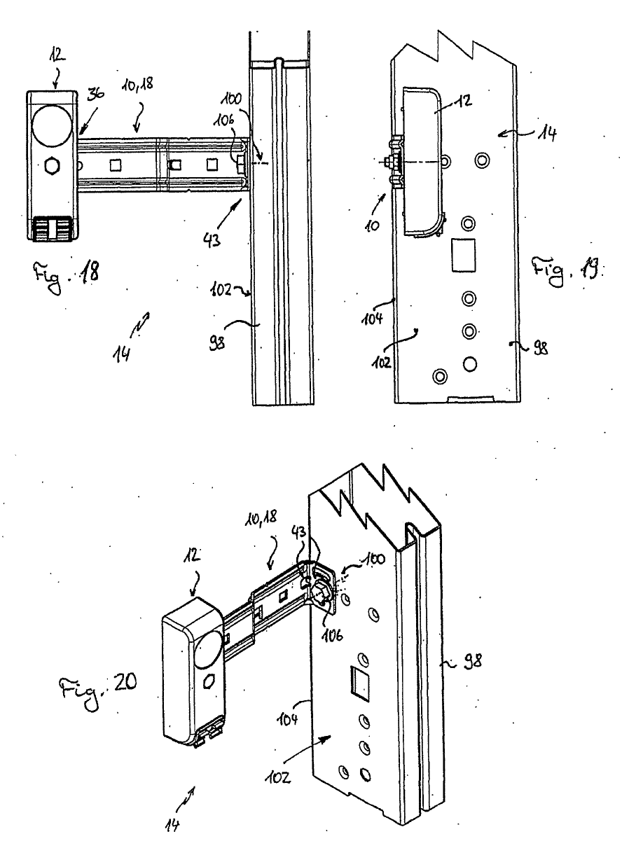

FIG. 13 is a view in perspective of a second position for floor mounting the light barrier housing and mounting bracket;

FIG. 14 is a view in perspective of a third mounting position of the light barrier housing and mounting bracket suitable for securing to a door frame of a single leaf overhead door;

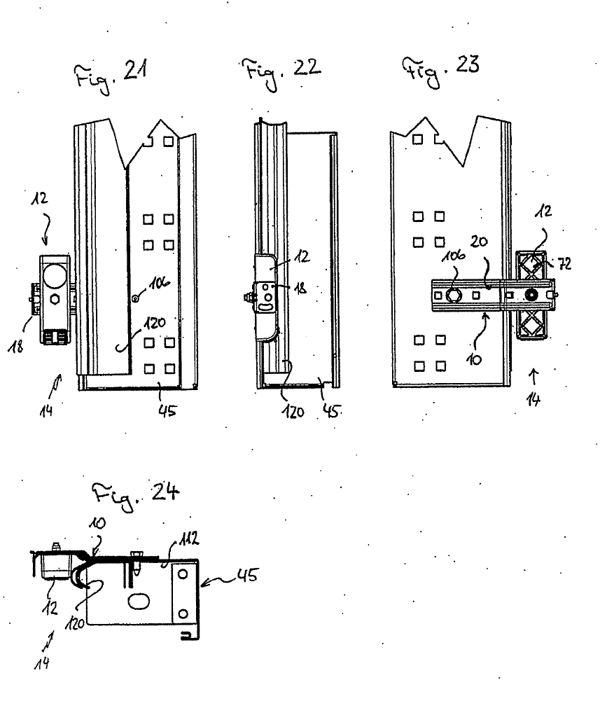

FIGS. 15 and 16 are front views of the first and second mounting position;

FIG. 17 is a side view of the third mounting position;

FIGS. 18 to 20 are diverse views of the light barrier housing secured to the door frame of a single leaf overhead door by means of the mounting fixture in the mounting position as shown in FIGS. 14 and 17:

FIGS. 21 to 27 are diverse views of a lower portion of a door frame of a sectional door with a light barrier element, the light barrier housing of which is secured by means of a mounting bracket as shown in FIGS. 1 to 7 in fourth mounting position to the door frame;

FIGS. 28 and 29 are illustrations of two differing embodiments of cable clips for simple routing of the connecting cables of the light barrier element;

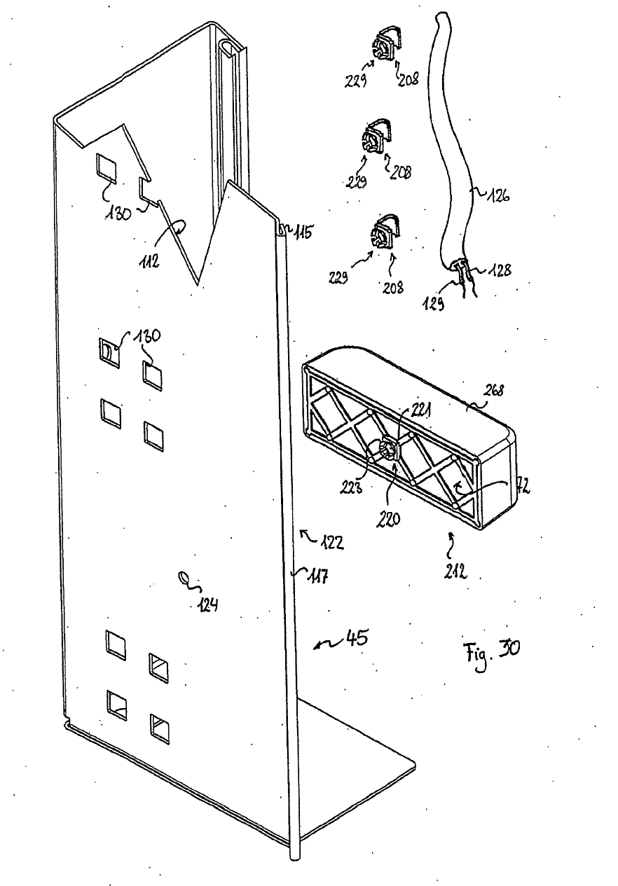

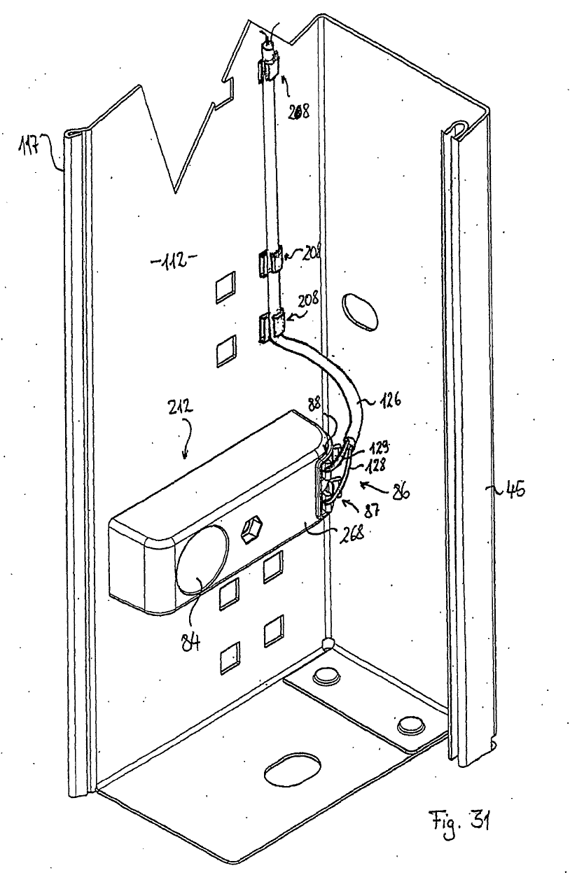

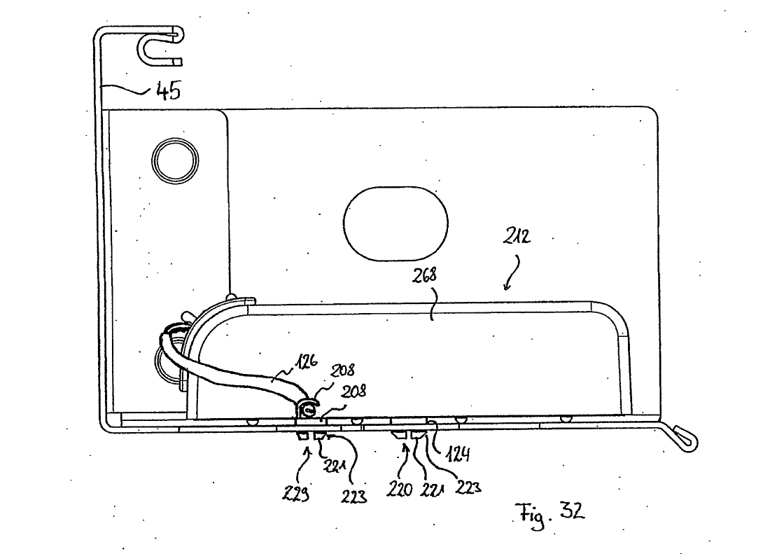

FIG. 30 is an exploded view in perspective of a lower portion of a door frame of a single leaf overhead door and a light barrier element in a further embodiment with wiring elements to illustrate a further possibility of securing the light barrier optionally either directly to the door frame or to the mounting fixture of the aspects as cited above;

FIG. 31 is a view in perspective of the assembly as shown in FIG. 30 as viewed from another direction to highlight the detent means employed izc;

FIG. 32 is a top-down view of the assembly as shown in FIGS. 30 and 31;

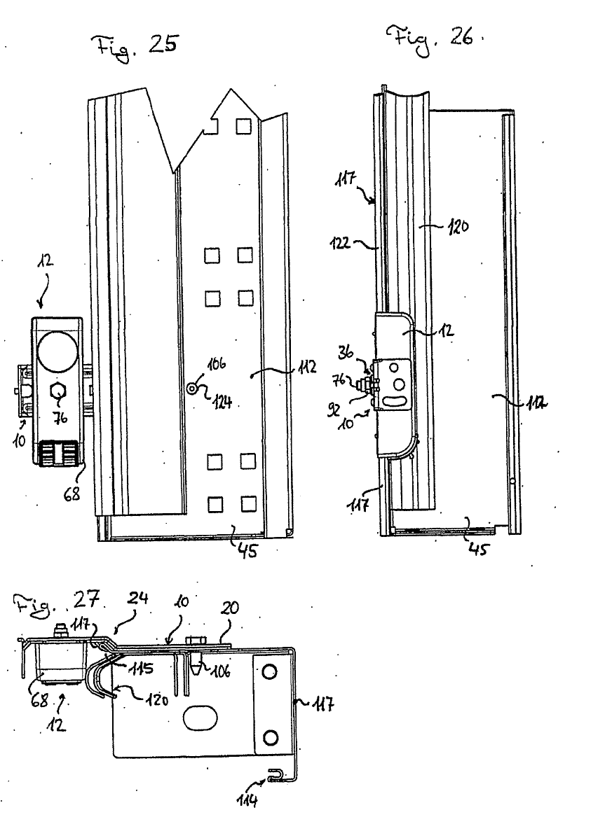

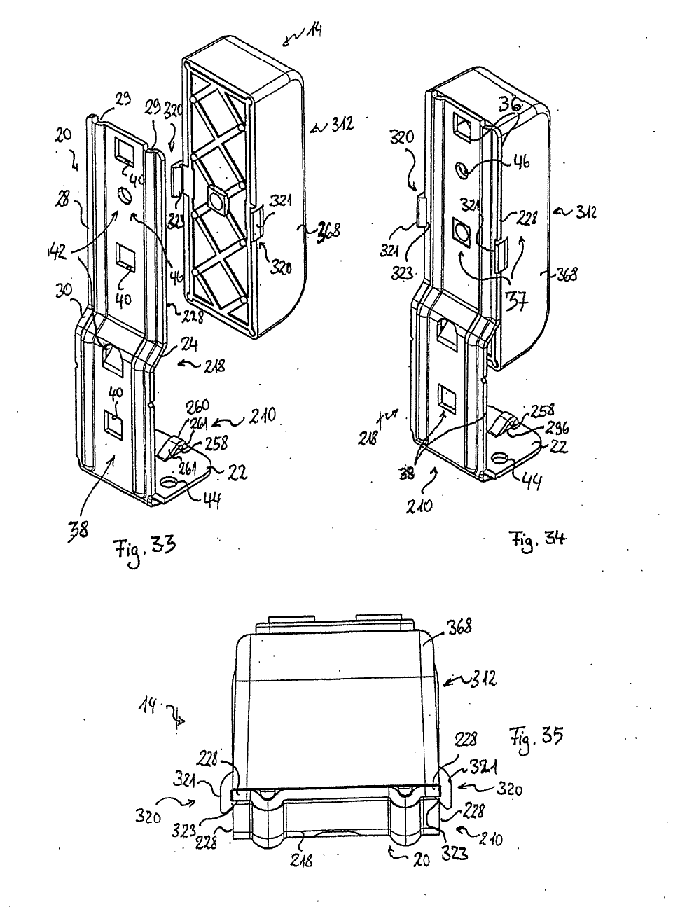

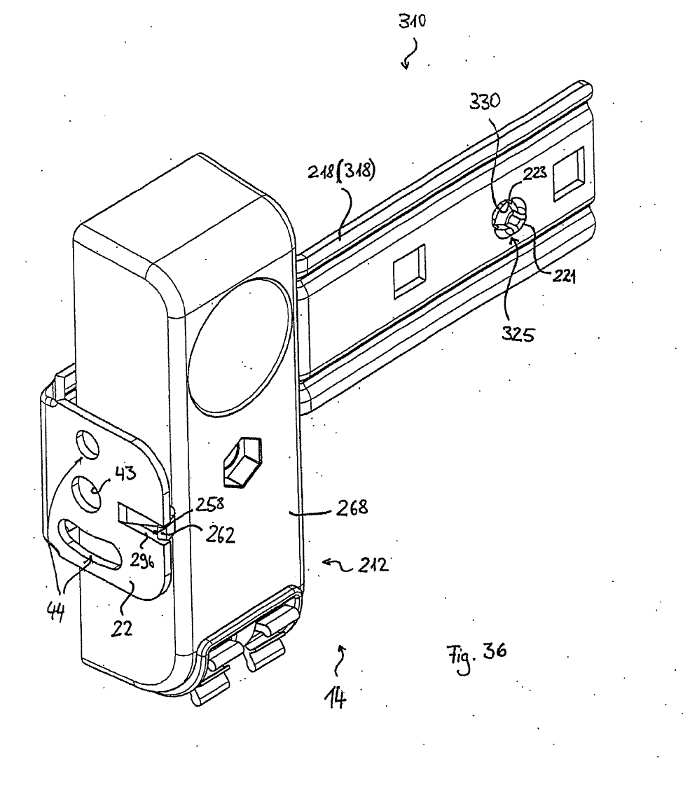

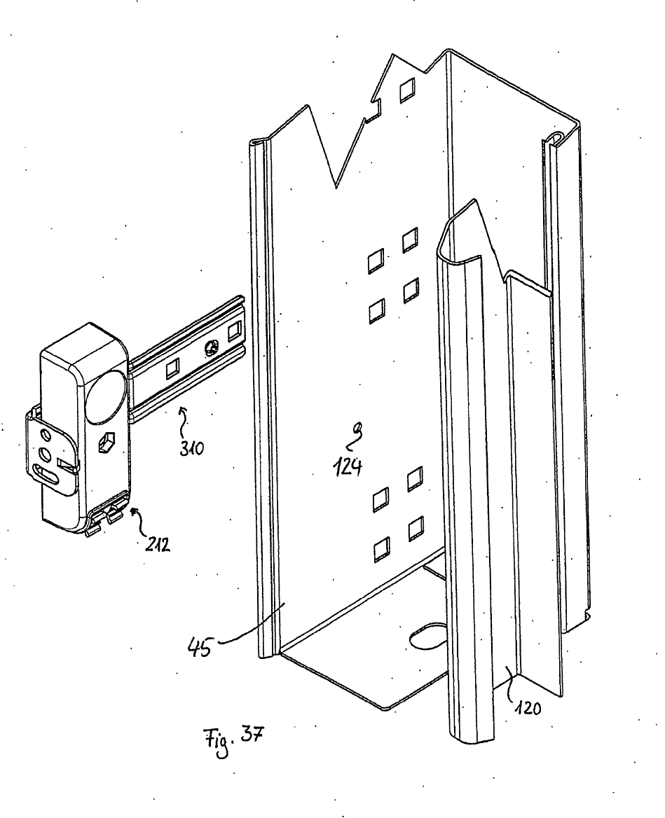

FIGS. 33 to 25 are diverse views of a first embodiment of a light barrier element securable by means of a second embodiment of a mounting fixture; and

FIG. 36 is a view in perspective of a themb of a mounting fixture for securing a light barrier element together with the light barrier element secured thereto;

FIG. 37 is a view in perspective of the assembly as shown in FIG. 36 together with a door frame of a single leaf overhead door; and

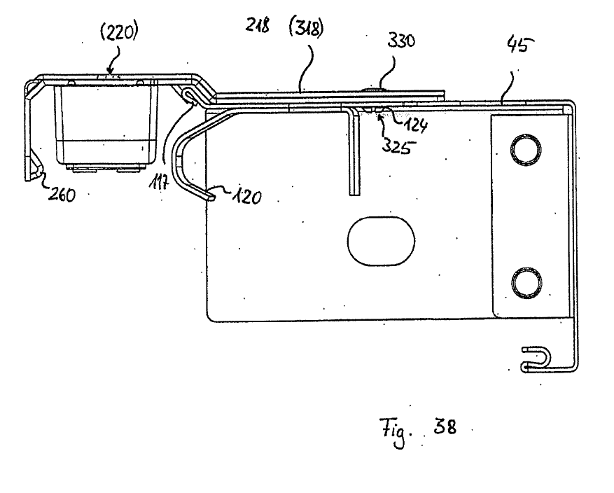

FIG. 38 is a top-down view of the assembly as shown in FIG. 36 securing to a door frame of a sectional door.

Referring now to FIGS. 1 to 6 there is illustrated a first embodiment of a mounting fixture 10 for a first embodiment of a light barrier element 12 (see for example FIGS. 8 to 11) of a light barrier device identified 14. As shown in FIGS. 18 to 27, the light barrier device 14 is intended for installing in a lower portion of a doorway so as to halt and/or reverse a door operator (not shown) should there be an obstacle in the doorway obstructing action of the door.

The mounting fixture 10 illustrated by itself without the light barrier element 12 in FIGS. 1 to 7 is engineered as a mounting bracket 18 made of metal, particularly sheet steel.

The mounting bracket 18 has a longer first leg 20 as well as shorter second leg 22 oriented substantially at right angles thereto. The first leg 20 is provided with an offset 24 so that a first portion 26 and a second portion 28 are oriented substantially staggered parallel to each other. Disposed between the first portion 26 and the second portion 28 the form the offset 24 is a inclined connecting portion 30 inclined aaa alpha of 46° to the first portion 26, second portion 28.

The orientation is such that the inclined connecting portion 30 at the one end of the first portion 26 and the adjoining second portion 28 protrudes in the same direction as the second leg 22 protrudes at the other end of the first portion 26, resulting in the mounting bracket 18 having roughly the shape of a “?” or a hook as viewed from the side (see for example FIGS. 4 and 6).

Except for a floor and wall fastening means 44 as detailed further on, the mounting bracket 18 is configured in all symmetrical to its longitudinal centerline 34.

Located centered on the longitudinal centerline 34 at the first leg 20 is a total of three first light barrier fastening means 36, 37, 38 each of which features a square notch 40. In this arrangement a first light barrier fastening means 36 is located at the free end portion of the second portion 28. The second portion 28 comprises furthermore also the second light barrier fastening means 37 at a middle section displaced nearer to the offset 24. The third light barrier fastening means 38 is arranged at the a middle section of the first portion 26.

The mounting bracket 18 features furthermore two door fastening means 42 and 43 as well as a floor and wall fastening means 44.

The first door fastening means 42 is devised for securing the mounting bracket 18 to the door frame 45 of a sectional door (for more details see FIGS. 21 to 27). As evident from FIGS. 1 to 7 the first door fastening means 42 features a first bolt fastening hole 46 and a positioning aid, in this case in the form of a first stopper means 48. The first stopper means 48 is located on the offset 24 likewise in the vicinity of the end portion of the first leg 20, namely as shown in this example between the first light barrier fastening means 36 and the second light barrier fastening means 37.

The first stopper means 48 comprises in the example as shown in this case inswept to the second leg 22 the connecting portion inside surface 54 of the inclined connecting portion 30 of the offset 24 as well as a clasping means 50. The clasping means 50 as shown in this example is configured as a bent-out tab 52 oriented substantially parallel to the inclined connecting portion 30. Disposed between the tab inside surface 53 of the tab 52 and the connecting portion inside surface 54 of the inclined connecting portion 30 is a spacing of 3.5±0.1 millimeters.

The second door fastening means 43 is assigned to the second leg 22, it likewise featuring a second bolt fastening hole 56 located central to the longitudinal centerplane running through the longitudinal centerline 34 as well as a positioning aid, here in the form of a second stopper means 58. As is best evident from FIG. 2 as well as from FIGS. 4 and 6 the second stopper means 58 comprises a second tab 60 bent away at a right angle from second leg 22 in the opposite direction of the first leg 20.

The floor and wall fastening means 44 too—for use in both securing the mounting bracket 18 of the floor of the bay to be closed off by the door being monitored, or a space before the doorway as well as on the surface of a door fastening, particularly a door frame of any kind of door and for securing to a wall (not shown) surrounding the doorway—features at the side edge portions of the second leg 22 a first bolt fastening hole and second bolt fastening hole 63 each. The first bolt fastening hole of the floor and wall fastening means 44 is located roughly on a transverse centerline through the second leg 22 and machined as a circular hole. The second bolt fastening hole 63 of the floor and wall fastening means 44 is machined as a curved slot 64 circularly curved about the center of the first bolt fastening hole.

Provided to stiffen the relative orientation of the first leg 20 and second leg 22 is an inswept ramped reinforcement portion 66 at both corner portions configured between the two legs 20, 22.

Provided furthermore to stiffen the mounting fixture 10 are beads 29 extending along the edge portions of the first leg 20 on the rear side of the first leg 20 to thus stiffen both portions 26 and 28 and the offset 24.

For further details of the mounting bracket 18 express reference is made to the fine detailed illustration.

Referring now to FIGS. 8 to 11 there is illustrated the light barrier element 12 of the light barrier device 14 as will now be detailed.

In accordance with a first embodiment the light barrier element 12 is seated in a first embodiment of a light barrier housing 68 which is rectangular in a front view. Communicating in a centerpoint transversely to the front side 70 to the rear side 72 is a through-hole 74 for a hexagon bolt 76 (see for example FIG. 12 or 14).

As evident from FIGS. 8-11 the through-hole 74 ports at the front side 70 into a hexagon recess 78 to locate the head of the hexagon bolt 76 non-rotatably.

At the rear side 72 the through-hole 74 ports into a square protuberance 80 protruding from the rear side 72 configured to precisely locate the square notches 40 of the light barrier fastening means 36, 37 or 38.

Provided furthermore at the rear side 72 is a total of eight hemispherical protuberances 82 which marry the beads 29 when the light barrier housing 68 is oriented parallel to the first leg 20. In this arrangement the distribution and arrangement of the protuberances 82 is such that the protuberances 82 arranged near to the square protuberance 80 also engage the beads 29 when the light barrier housing 68 is oriented transversely to the first leg 20.

It is this protuberance/recess combination between the protuberances 80, 82 and the notches and beads 40, 29 respectively that the light barrier housing 68 can be optionally oriented in a total of four (and not more) ways at the first and second light barrier fastening means 36, 37. Because of the first portion 26 being backswept a longitudinal orientation of the light barrier housing 68 and the first leg 20 is not possible at the third light barrier fastening means 38 arranged at this portion, i.e. here there are only two options available for orienting the light barrier housing 68 relative to the first leg 20.

For cost-effective production the light barrier housing 68 is preferably made of a tough high-strength plastics material.

Provided in the light barrier housing 68, to form the light barrier element 12, in each case is a sensor of the light barrier which can be a transmitter or a receiver. To form the light barrier 14 a light barrier housing 68 provided with a transmitter needs to be secured to the one side of the door by means of the mounting fixture 10 and a light barrier housing 68 provided with an receiver needs to be secured to the other side of the door by means of the mounting fixture 10.

It is furthermore possible to provide in the light barrier housing 68 a transceiver with simply a reflector being located at the other end of the doorway.

Provided preferably in the light barrier housing 68 is a photodiode 84 with its assigned electronic circuitry (not shown) serving as a transmitter or as a receiver depending on how it is activated.

In the example as shown the light barrier element 12 is engineered as a two-wire system as is known in principle. For more details as regards the inner structure of the light barrier element 12 and how the light barrier 14 works as regards the two-wire connection and its circuiting with the door operator (not shown) reference is expressly made to German patent DE 20 2004 005 113 U1 making special mention that and how the light barrier element 12 can be operated with two cables as either an transmitter or as a receiver structured roughly the same depending on how activated and circuited.

To simplify connecting the two cables a connector in the form of a cable connector 86 with two connector clips 87, 88 is provided in a lower portion near to the bottom edge of the front side 70 as are popular with home stereo speaker connectors. The two connector clips 87, 88 thus featuring a contact element or clip element 89 biased in the clipped position by spring tension and featuring a finger scallop 90 for finger tip actuation from its clipped position by opening the central portion into which the stripped end of the cable can be inserted and which on removal of finger pressure results in the spring bias of the clip element 89 clamping the stripped end of the cable between metal surfaces in contact. Such connector clips are popular in the electronics marketplace as speaker terminals.

FIGS. 12, 13, 15 and 16 show differing positions for floor mounting the light barrier element 12.

Referring now to FIGS. 12 and 15 there is illustrated a first mounting position in which the light barrier housing 68 is secured lengthwise to the first leg 20 to the second light barrier fastening means 37. In this arrangement, as is particularly evident from FIG. 12 the light barrier housing 68 ends flush with the first leg 20 at the top, it being simply secured by the hexagon bolt 76 inserted in the through-hole 74 and locked in place at the rear by a nut 92 at the rear side as shown in a comparable arrangement in FIG. 17 for another mounting position.

There is provided, as shown in FIGS. 12 and 15, for example, for floor (or wall mounting) two bolt/dowel combinations 94 by means of which the mounting bracket 18 can be securely fastened by engaging two holes drilled correspondingly in the floor by a floor or wall fastening means 44. The second tab 60 protruding downwards may also deviate upwards in this floor mounting because of the larger recess 96 in the first leg 20 so that the second leg 22 can rest flush and flat on the floor in thus assuring precise vertical orientation of the light barrier element 12.

Orienting the light beam transmitted or received by the photodiode 84 is possible because of a curved slot 64 by turning the mounting bracket 18 about a bolting hole 62 with the bolt/dowel combinations 94 inserted.

Referring now to FIGS. 13 and 16 there is illustrated a second mounting position which is comparable to the first mounting position as shown in FIGS. 12 and 15, except that the light barrier housing 68 is secured to the first light barrier fastening means 36 in thus being positioned higher than in the first mounting position.

Referring now to FIGS. 14 and 17 there is illustrated a third mounting position in which again the light barrier housing 68 is secured to the first light barrier fastening means 36, but this time transversely to the projection of the first leg 20. In this way the mounting bracket 18 can be secured to a vertical surface oriented roughly parallel to the plane of the doorway, for example to a wall or especially to a door frame. Depending on the wanted or necessary spacing of the light barrier from the fastening location the first light barrier fastening means 36 or optionally also one of the other two second light barrier fastening means 37, 38 can be used in this transverse fastening, as shown. When making corresponding use of the floor and wall fastening means 44 the second leg 22 can be fitted by means of two bolts to the two holes drilled by the light barrier fitter, in thus enabling the mounting bracket 18 to be secured to any wall or door frame as available. When secured to a wall the spacing achievable by means of the mounting bracket assures that the light barrier “sees” past any projecting parts of the door, for example door frame or counterweighing means.

In the same mounting position it is, however, also possible to use the second door fastening means 43 for securing to an adapting door frame 98 of a up and over door or the like, as detailed below with reference to FIGS. 18 to 20.

Shown in FIGS. 18 to 19 is the lower portion of a door frame 98 for a single leaf overhead door as is known for example from German patents DE 101 53 366 A1, DE 298 155 07 U1, DE 298 15 487 U1, DE 100 95 745 C2 or DE 101 50 000 B4 as well as from the “Berry Up and over Door” publication 12.04 HF 85187/G.50 of the firm Hörmann KG. Express reference is made to all of these publications as to further details as to such up and over doors or other single leaf overhead doors.

The door frame 98 as shown in the FIGS. 18-20 differs from the door frames of these known single leaf overhead doors particularly by a special bolting hole 100 provided in the factory in a wall 102 of the door frame 98 facing the doorway to be closed off at a level above the floor as suitable for installation of the light barrier spaced away from an edge 104 of the door frame 98 facing away from the doorway to be closed off as adapted to the second door fastening means 43. This spacing of the bolting hole 100 provided in the wall 102 of the door frame 98 from the edge 104 thus corresponds to the spacing of the second stopper means 58 from the second bolt fastening hole 56 and is in the range 10 to 20 mm, particularly approximately 15 mm in our example.

The bolting hole 100 can be prefabricated tapped for a corresponding bolt, but preferably the mounting fixture 10 in accordance with a first embodiment is furnished with a self-tapping bolt 106 for mounting to the door frame 98 or to the door frame 45 of a sectional door as detailed below.

To fit the light barrier element 12 to the door frame 98 of the up and over door, firstly the mounting bracket 18 is positioned by suitable applying the second stopper means 58 to edge 104 so that the second bolt fastening hole 56 is inline with the bolting hole 100, before the mounting bracket 18 is secured to the door frame 98 with the self-tapping bolt 106. The light barrier housing 68 is secured as located with reference to FIGS. 18 to 20—either previously or afterwards—by means of the hexagon bolt 76 and the nut 92. All that then needs to be done is to connect the two-wire cable 126 (FIGS. 28 and 29) to the connecting device 86 by means of the connector clip 87 and 88. The other end of the two-wire cable 126 is connected to the door operator controller (not shown). The two-wire cable 126 can be neatly routed by means of self-adhesive cable clips 108 and 110 (see FIG. 28 or FIG. 29). These cable clips 108 or 110 can be furnished with the mounting fixture 10 in adequately quantity as an accessory package.

Referring now to FIGS. 21 to 27 there is illustrated how the light barrier element 12 is secured to the door frame 45 of a sectional door (not shown) by means of the mounting fixture 10.

When mounted in this way the first leg 20 serves both to make the securement to the door as well as to the light barrier element 12. In this case the light barrier housing 68 is secured transversely to the third light barrier fastening means 38 by means of the hexagon bolt 76 and the nut 92. The second leg 22 is not needed for fastening but can function to protect the light barrier housing 68 from side impact.

To secure the mounting fixture 10 to the door frame 45 the first door fastening means 42 is used. The sectional door involved (not shown) is particularly of the type as is known from the publication “Garage sectional doors” S.09.05/DOOR.09.05/HF851841/G100 (i.e. printed in September 2005 and distributed directly among other things over Internet) of the firm Hörmann KG, to which express reference is made as to further details.

As evident from FIG. 27 in particularly the new door frame 45 as shown in this FIG. comprises an L-section wall 112 with a roughly L-shaped cross-section reinforced at both if its ends by foldbacks 114, 115. The end edge 117 provided with the foldback 115 is directed into the doorway to be closed off and in the example as illustrated in this case is configured at an angle of 44-46° away from the doorway to be closed off. Provided at the inner portion of the L-section wall 112 adjoining this end edge 117 a tracks 120 for guiding the panels of the sectional door leaf. In the vicinity of these tracks 120 the L-section wall 112 is provided with a predefined bolting hole in the form of a circular hole 124 at a level suitable for mounting the light barrier. The spacing of the hole 124 from the end edge 117 forming an edging 122 is in this arrangement selected so that when this edging 122 engages between the clasping means 50 and the offset 24 the hole 124 is inline with the first bolt fastening hole 46 of the square protuberance 80. In the example as shown the spacing between the root of the edging 122 and the hole 124 is precisely as much as the spacing of the end of the second portion 28 facing the offset 24 from the center of the first bolt fastening hole 46, namely approximately 46 mm.

It is in this way that the mounting fixture 10, simply with the first stopper means 48 formed by the clasping means and the offset 24, is mounted on the edging 122 and subsequently fixed in place with the self-tapping bolt 106. This thus now makes it very easy to fit the light barrier element in precisely defined location on the door frame 45. In this arrangement the spacing between the clasping means 50 and the offset 24 can be selected such that it results in a clamped seating on the edging 122 so that there is not even a need to hold the mounting bracket 18 secure when bolting it in place.

When fitting the system to the door frame 45 too, it is again simple to make the connection of the two-wire cable 126 by means of the connector clips 87 and 88, whilst routing the first wire 128 up to the door operator controller is in turn simple by means of the self-adhesive cable clips 108 or 110.

In the example as shown, the light barrier 14 can be furnished particularly as an accessory package for any type of door operator, compatible with operators for different types of doors, for example, both sectional and overhead doors. Such an accessory comprises two intercompatible light barrier elements 12 for forming a light barrier as well as two mounting fixtures 10 and the various fasteners 76, 92, 94, 106, a length of two-wire cable 126 for connecting both light barrier elements 12 as well as a plurality of self-adhesive cable clips 108 and 110 respectively.

In addition to mounting the light barrier housing 68 by means of the mounting fixture 10 the through-hole 74 also makes it possible to fit the light barrier housing 68 directly to a wall, for example, a wall running transversely to the plane of the doorway, for instance in the reveal area of the doorway.

Referring now to FIGS. 30 to 32 there is illustrated a second embodiment of a light barrier element 212 as an example of one such direct securement to the door frame 45 of the sectional door, whereby like or corresponding components have like reference numerals as in the first embodiment.

Except for the light barrier housing 268 the light barrier element 212 of the second embodiment corresponds to the light barrier element 12 of the first embodiment. The light barrier housing 268 of the second embodiment differs from the light barrier housing 68 of the first embodiment solely by a first detent means 220 at the rear side 72.

Instead of the through-hole 74 the first detent means 220 features four detent tongues 221 each diametrally opposed to the other and provided at sides facing away from each other a detent nose 223. The detent tongues 221 are engineered elastically squeezable.

This enables the first detent means 220 to be clipped into place in a hole 124 drilled for securing the light barrier so that it can be positioned, for example, on the inside surface of a L-section wall 112. Positioning aids can be provided at the inside surface of the L-section wall 112 in one aspect (not shown) of this embodiment to position the light barrier housing 268 oriented as preselected. These positioning aids may be provided as stops or recesses for positively connected parts of the light barrier housing 268.

Referring still to FIGS. 30 to 32 there are illustrated alternative aspects of cable clips 208, each of which can be lip by integral second detent means 229 in square notches 130 in the door frame 45. These square notches 130 are provided on a regular spacing along the door frame 45 in the L-section wall 112, defining a path within the L section of the door frame 45 for routing the cable two-wire cable 126 both safely, favorably and facilitated.

The square notches 40 in the mounting bracket 18 have in one preferred embodiment the same dimensions as the square notches 130 in the door frame 45 in thus enabling, when required, one of the cable clips 208 to also be clipped in place in one of the notches 40 in the mounting bracket 18 so as to route and locate the cable two-wire cable 126 in the immediate vicinity of the light barrier element 12. For instance, the cable 126 can be safely routed around and behind the mounting bracket 18 so that the cable 126 cannot flutter because of wind gusts and shock impact, for example, disturbing the light path.

Referring still to FIGS. 30 to 32 there are also illustrated two leads 128 and second lead 129 of the cable 126 and their connection to the connector clips 87 and 88.

The first bolting hole 46 of the mounting bracket 18 forming the mounting fixture 10 in a first embodiment is dimensioned comparable to the hole 124 in the door frame 45. Thus, instead of directly securing the light barrier housing 268 as shown in FIGS. 30 to 32 in explaining the arrangement, in the second embodiment the light barrier element 212 can be clipped into place by means of the first detent means in the mounting bracket 18 and then optionally secured in the region of any door by means of the mounting bracket 18.

Referring now to FIGS. 33 to 35 there is illustrated a second embodiment of a mounting fixture 210 with a modified mounting bracket 218 for securing a light barrier element 12, 212 together with a light barrier element 312 in accordance with a third embodiment, like or correspondingly components having like reference numerals as in the embodiment as discussed above to which reference is also made for more details.

The mounting bracket 218 in its second embodiment differs from the first mounting bracket 18 of the first embodiment merely by the recess 96 with the assigned second tab 60 being omitted. Instead of this, the second door fastening means 43 with this second portion 28 features at the second leg 22 a third tab 260 arranged in the region of the free end of the second leg 22. The third tab 260 firstly features a longer middle portion 261 swept back at an angle to the side of the first leg 20 and its edge portion again swept back to the second leg 22 forming an downswept end 262. The third tab 260 is oriented within a notch 296 machined in the free edge portion of the second leg 22 in thus protruding inwards only to the first leg 20. The mounting bracket 218 can thus be located by its rear also very near to a wall without the rear side tab 60 getting in the way. Now, when the second door fastening means 43 is needed as a positioning aid, as described above, the third tab 260 simply needs to be depressed until the bent end 262 protrudes roughly at a right angle below the second leg 22. This results in a third stopper means 258 being formed at the underside of the second leg 22 which can be put to use like the second stopper means 58 of the first embodiment. Because of the longer middle portion 261 a longer lever is formed for depressing than that when depressing the second tab 60 in thus making for a more facilitated handling in all.

The light barrier housing 368 in accordance with a third embodiment is configured the same as light barrier housing 68 in the first embodiment, except that a third detent means 320 is now additionally configured at the rear side 72 for detesting at the long outer edges 228 of the mounting bracket 18, 218.

The third detent means 320 comprises in the middle of the longer side edges of the rear side 72 of the light barrier housing 368 a detent tongue 321. Each detent tongue 321 comprises at the side inswept to the light barrier housing 368 a detent nose 323 for clasping the edges 228 of the mounting bracket 218. For this purpose the detent tongues 320 can be elastically splayed.

In accordance with another embodiment (not shown) two of the square notches 40 at the mounting bracket 18, 218 are configured spaced so far from each other that the two detent tongues 320 can also engage the two square notches 40 to clasp the rims there. This enables the light barrier housing 368 to be optionally latched in place either oriented with the mounting bracket 18, 218 as shown in FIGS. 13 to 15, or oriented perpendicular to the longitudinal extent of the mounting bracket 18, 218 as shown in FIG. 14, for instance, with the mounting bracket 18, 218. In this arrangement means are provided at mounting bracket 18, 218 and/or the light barrier housing 368 so that the protuberance 80 can be shaped to engage a corresponding notch (not shown) in the mounting bracket 18, 218 also when oriented at right angles.

Referring now to FIGS. 36 to 38 there is illustrated in conclusion a third embodiment of the mounting fixture 310 corresponding essentially to the first or second embodiment except that configured at the mounting bracket 318 is a fourth detent means 325 by means of which the mounting bracket 318 is securable to the door frame 45. For this purpose the fourth detent means 325, like the first detent means 220, is configured with the four detent tongue 221 enabling the fourth detent means 325 to be locked in the 124 of the door frame 45.

To produce the fourth detent means 325 the mounting bracket 318 in accordance with the third embodiment can be fully injection molded in a plastics material, the fourth detent means 325 being molded integral instead of the first bolt fastening hole 46 of the mounting bracket 18 in the first embodiment. As an alternative the mounting bracket 218 or mounting bracket 18 of the second or first embodiment can be used, there being inserted in the first bolt fastening hole 46 a pin-shaped clip fastener 330 featuring at the end covered by the mounting bracket 218 in the illustration as shown in FIG. 36 a flat wider head (not shown), passing through the first bolt fastening hole 46 by a neck portion provided with the detent tongue 221. With the aid of one such clip fastener 330 the mounting bracket 218 can be secured without a tool simply by clipping it to the 124.

Otherwise, as evident from FIG. 38, making the securement is the same as for the bolted arrangement as shown in FIGS. 21 to 27.

### LIST OF REFERENCE NUMERALS

10 mounting fixture (first embodiment)
12 light barrier element (first embodiment)
14 light barrier device
18 mounting bracket (first embodiment)
20 first leg
22 second leg
24 offset
26 first portion
28 second portion
29 beads
30 inclined connecting portion
34 longitudinal centerline
36 first light barrier fastening means
37 second light barrier fastening means
38 third light barrier fastening means
40 square notch
42 first door fastening means
43 second door fastening means
44 floor and wall fastening means
45 door frame (sectional door)
46 first bolt fastening hole
50 clasping means
52 tab
53 tab inside surface
54 connecting portion inside surface
56 second bolt fastening hole
58 second stopper means
60 second tab
62 first bolt fastening hole of floor or wall fastening means
63 second bolt fastening hole of floor or wall fastening means
64 curved slot
66 ramped reinforcement portion
68 light barrier housing (first embodiment)
70 front side
72 rear side
74 through-hole
76 hexagon bolt
78 hexagon recess
80 square protuberance
82 protuberances
84 photodiode
86 connecting device
87 connector clip
88 connector clip
89 contact element
90 finger scallop
92 nut
94 bolt/dowel combination
96 recess
98 door frame
100 bolting hole
102 wall
104 edge
106 self-tapping bolt
108 cable clip
110 cable clip
112 L-section wall
114 foldback
115 foldback
117 end edge
120 tracks
122 edging
124 (bolting) hole
126 two-wire cable
128 first lead
129 second lead
130 square door frame notches
208 cable clip
210 mounting fixture (second embodiment)
212 light barrier element (second embodiment)
218 mounting bracket (second embodiment)
220 first detent means
221 detent tongue
223 detent nose
228 outer edges of mounting bracket
229 second detent means
258 third stopper means
260 third tab
261 middle portion
262 downswept end
293 notch
268 light barrier housing (second embodiment)
310 mounting fixture (third embodiment)
318 mounting bracket (third embodiment)
320 third detent means
321 detent tongue
323 detent nose
325 fourth detent means
368 light barrier housing (third embodiment)

1. A mounting fixture being configured to secure a light barrier element of a light barrier device in the region of a doorway to be closed off by a door, comprising:
at least one light barrier fastening means for securing the light barrier element to the mounting fixture;
at least one first door fastening means for securing the mounting fixture to a door element of a first type of door; and
at least one second door fastening means for securing the mounting fixture to a door element of a second type of door.

2. The mounting fixture as set forth in claim 1, for securing a light barrier element of a light barrier device in the region of a doorway to be closed off by a door, further comprising
at least one light barrier fastening means for securing the light barrier element to the mounting fixture,
at least one door fastening means for securing the mounting fixture to an element of a door, and
at least one floor or wall fastening means for securing the mounting fixture to the floor or to a wall in the region of the doorway.

3. The mounting fixture as set forth in claim 1, wherein the mounting fixture is a mounting bracket having a first leg and a second leg oriented substantially at right angles thereto.

4. The mounting fixture as set forth in claim 3, wherein the first leg is longer than the second leg.

5. The mounting fixture as set forth in claim 4, wherein the first leg is configured offset with a backswept first portion adjoining the second leg at one end of the first leg and a second portion at the other end of the first leg, the second portion being foreswept in the direction of the second leg relative to the first portion.

6. The mounting fixture as set forth in claim 1, wherein at least two light barrier fastening means spaced away from each other are provided for securing the light barrier element differingly spaced from the door elements and/or the floor respectively from a wall and/or for securing the light barrier element being differingly oriented.

7. The mounting fixture as set forth in claim 6, wherein
the mounting fixture is a mounting bracket having a first leg and a second leg oriented substantially at right angles to each other, and the first leg is longer than the second leg,
the first leg is configured offset with a backswept first portion adjoining at one end the second leg and at the other end a second portion of the first leg, the second portion being foreswept in the direction of the second leg relative to the first portion, and
a first light barrier fastening means and at least one further light barrier fastening means are arranged at the first leg.

8. The mounting fixture as set forth in claim 7, wherein the first and a second light barrier fastening means are both arranged on the second portion.

9. The mounting fixture as set forth in claim 7, wherein the first light barrier fastening means is arranged on the second portion and a further light barrier fastening means is arranged on the first portion.

10. The mounting fixture as set forth in claim 1, wherein the at least one light barrier fastening means includes at least one non-round, particularly polygonal rimmed notch arranged on a longitudinal centerline of the mounting fixture.

11. The mounting fixture as set forth in claim 1, wherein the at least one light barrier fastening means is configured with a protuberance and/or a recess for receiving a recess and protuberance respectively at the light barrier element for precise positioning.

12. The mounting fixture as set forth in claim 1, wherein the at least one light barrier fastening means is configured for securing a light barrier housing, the light barrier housing is securable to the mounting fixture oriented both substantially along the projection of the mounting fixture and substantially transversely to the projection of the mounting fixture.

13. The mounting fixture as set forth in claim 1, wherein at least one door fastening means is configured for securing the mounting fixture to a door frame.

14. The mounting fixture as set forth in claim 13, wherein the at least one door fastening means has a hole for a fastener, and stopper means for engaging an edge of the door frame positively connected and/or non-rotatably connected.

15. The mounting fixture as set forth in claim 14, wherein the stopper means includes a tab and/or an offset protruding from the mounting fixture.

16. The mounting fixture as set forth in claim 15, wherein, the mounting fixture is configured with two portions staggered substantially parallel to each other for securing to a sectional door frame provided with an inclined protruding edging, at least one light barrier fastening means is configured at the first portion and the hole is configured at the second portion, the hole is configured for engaging a fastener of at least one first door fastening means or a second fastener configured to be integral with the mounting bracket of at least one first door fastening means.

17. The mounting fixture as set forth in claim 16, wherein the stopper means includes the offset, the first door fastening means further includes at the first portion in the vicinity of the offset a clasping means with which the edging adjoining the offset is claspable.

18. The mounting fixture as set forth in claim 17, wherein the clasping means forms with the offset a notch 3 to 4 mm wide for receiving the edging.

19. The mounting fixture as set forth in claim 16, wherein the offset extends at an angle of approximately 44° to 48° to the first and second portions.

20. The mounting fixture as set forth in claim 16, wherein the center of the hole or of the second fastener of the first door fastening means is spaced 44 to 48 mm from the stopper means and offset respectively.

21. The mounting fixture as set forth in claim 3, wherein the mounting figure is configured for securing to a door frame of a single leaf overhead door, the door fastening means configured for this purpose being provided at the second leg.

22. The mounting fixture as set forth in claim 14, wherein the stopper means of the door fastening means is configured for being secured to the frame of the single leaf overhead door is provided on the side of a second leg opposite a first leg jutting away from the second leg.

23. The mounting fixture as set forth in claim 21, wherein the stopper means of the door fastening means is configured for being secured to a frame of a single leaf overhead door and is spaced away from the center of an assigned fastener notch or from an assigned integrally configured fastener by 14 to 16 mm.

24. The mounting fixture as set forth in claim 2, wherein the floor or wall fastening means is configured at a second leg, and the floor or wall fastening means includes a first bolting hole for a first bolt fastener and spaced away therefrom a second bolting hole for a second bolt fastener, the second bolting hole being a slot curved about the first bolting hole as the centerpoint.

25. The mounting fixture as set forth in claim 1, wherein the light barrier fastening means and/or at least one door fastening means is configured as part of a clip or detent connection.

26. The mounting fixture as set forth in claim 25, wherein the light barrier fastening means includes a recess or edging claspable by a detent means of the light barrier device and that at least one door fastening means includes a further detent means configured for clasping a corresponding recess or edging at the element of a door.

27. The mounting fixture as set forth in claim 25, wherein the at least one door fastening means comprises a recess or edging claspable by a detent means at the door and that the light barrier fastening means includes a further detent means configured for clasping a corresponding recess or edging at the light barrier device.

28. A light barrier device (14) for a door operator, comprising:
at least one mounting fixture according to claim 1; and
at least one light barrier element including a light barrier housing.

29. The light barrier device as set forth in claim 28, wherein the light barrier housing has a through-hole for a bolt fastener for the purpose of securing it to the mounting fixture.

30. The light barrier device as set forth in claim 28, wherein the light barrier housing is securable to a light barrier fastening means of the mounting fixture oriented in one to eight selectable ways.

31. The light barrier device as set forth claim 28, wherein the light barrier housing includes detent means for clasping a recess or an edging at the door or at the mounting fixture.

32. The light barrier device as set forth in claim 31, wherein the detent means includes a plurality of detent tongues configured to engage a hole at the door or at the mounting fixture and which are configured at sides facing away from each other with at least one detent nose each and which are elastically squeezable for detenting.

33. The light barrier device as set forth in claim 31, wherein the detent means includes a plurality of detent tongues configured for clasping two edges facing away from each other at the door or at the mounting fixture and which are configured at sides facing away from each other with at least one detent nose each and which are elastically squeezable for detenting.

34. A door operator system for powering a door, comprising:
at least one mounting fixture as set forth in claim 1; and
a door operator including a motor and a controller;
at least one light barrier device.

35. A door comprising:
a mounting fixture as set forth in claim 1;
a door element that is configured to be fixedly secured;
a door leaf; and
a light barrier device having a light barrier element of the light barrier device securable by the mounting fixture.

36. The door as set forth in claim 35, wherein the door element that is configured to be fixedly secured is provided at predefined locations and at specific levels with prefabricated fastening elements configured for engaging and/or being engaged by the door fastening means or one of the door fastening means.

37. The door as set forth in claim 36, wherein the door element that is configured to be fixedly secured is provided on each side of the doorway with at least one fastening elements such that mounting fixtures for a transmitter and/or receiver of the light barrier device are securable in an arrangement adapted to each other and at a level as predefined by the fastening elements.

38. The door as set forth in claim 35, wherein the door element that is configured to be fixedly secured is fitted likewise with a light barrier fastening means for directly securing the light barrier housing, configured in accordance with the light barrier fastening means of the mounting fixture.

39. The door as set forth in claim 35, wherein the door element that is configured to be fixedly secured is provided with prefabricated cable fastening elements for routing a connecting cable of the light barrier element at the door element to be fixedly secured.

40. A door system, comprising:
differing types of doors each having a door element adapted for fitting a light barrier by means of a mounting fixture as set forth in claim 1;
the mounting fixture;
a light barrier device mountable with the mounting fixture; and
one or more differing types of door operator, suitable for operating at least one of the door types and activatable by means of the light barrier device.
